(19) United States
(12) Patent Application Publication
(10) Pub. No.: US 2014/0208895 A1
(43) Pub. Date: Jul. 31, 2014

(54) ROTARY INDEXING TABLE

(71) Applicant: GIMATIC S.p.A., Roncadelle (IT)

(72) Inventor: Giuseppe Maffeis, Roncadelle (IT)

(73) Assignee: GIMATIC S.p.A., Roncadelle (IT)

(21) Appl. No.: 14/143,962

(22) Filed: Dec. 30, 2013

(30) Foreign Application Priority Data
Jan. 30, 2013 (IT) BS2013A000007

(51) Int. Cl. B23Q 16/02

(52) U.S. Cl. CPC B23Q 16/022
USPC 74/813 R

(57) ABSTRACT

An indexing table, or index table is provided including a mechanical type activating mechanism activated by a pneumatic or electric actuator. The activating mechanism of the table imparts to the latter an intermittent rotating movement as the actuator operates. The activating mechanism includes a thrust plate connected to the actuator, a double rack element capable of translations integral with the thrust plate and translation movements with respect to the same thrust plate, and a drive shaft of the table. The two racks engage the drive shaft alternately and impart rotations thereto in the same direction.

### FIELD OF THE INVENTION

The present invention relates to an indexing rotary table, in particular a rotary table provided with an innovative activating mechanism, designed to handle items among several workstations.

### BACKGROUND

In the field of the industrial automation, the use of rotary tables is known on which items are positioned to be fed in temporal succession to workstations arranged with a constant step around the table. Usually, the table rotation happens on an axis orthogonal to the table itself.

Such a type of rotary table, subjected to the action of an actuator and an activating mechanism, displaces at the same time all the items positioned on the same table among an initial angular position and several final angular positions, the table stopping for the preset time as these positions are reached, i.e. the time the slower workstation needs for ending its own intervention on the received item. Obviously the rotation can be clockwise or counter-clockwise, according to needs.

The number of angular positions in which the temporary stopping of table is provided is usually identified with the expression number of indexes, or stations, of the table. In practice, the number of table indexes is equivalent to the number of angular partitions or sectors equal one to another that are provided in a complete table turn. For example, a table with four equal indexes carries out intermittent rotations of 90° and a table with eight equal indexes carries out intermittent rotations of 45°.

Usually, indexing tables are also called as index table.

Conventionally, in table with pneumatic actuator the activating mechanism driving the intermittent rotary motion of the table is a mechanism carrying out the so-called pilger step. It is a lever-, cam-based mechanism, etc., converting two forth and back runs of the pneumatic actuator in one single run of table between two stations. Obviously this solution is not particularly efficient from the energy pointy of view; it is desirable to have an activating mechanism better converting the energy the actuator provides, for example a mechanism in which each actuator run would correspond to a table run. In addition, such a type of solutions often proved to be bulky, and this affects negatively the respective versatility.

As an alternative, activating mechanisms of cam and follower type have been proposed and became widely popular, in which a cam provided with an appropriate profile, continuously rotated by the actuator, drives into an intermittent rotary motion the follower integral with the table. These solutions proved to be reliable and accurate in precision of positioning. However, they suffer from the drawback that it is necessary to change the activating cam in order to vary the number of table indexes, and the cam is expensive.

Also activating mechanisms with planetary gears have been proposed, as described for example in U.S. Pat. No. 6,220,116. These solutions often suffer from vibrations arising by the interaction among gear wheels.

In other known solutions the actuator is an electric motor whose shaft is directly coupled to the table; sophisticated and expensive electronic controlling devices adjust the operation of the electric motor to obtain the intermittent rotation of the shaft. For example, US 2007/137433 describes an indexing table activated by an AC electric induction motor, feedback controlled by an electronic positioning device.

A lot of solutions with pneumatic actuator use electrovalves activated by a program for stopping the actuator movement in positions in which the table stops.

The use of electronic device to control the actuator or the activating mechanism involves, de facto, an increase of production and maintenance costs of tables; in addition, these devices are usually delicate and not adapted to operate in environments with great temperature ranges, vibrations, etc. Furthermore, electronic devices often do not allow obtaining the desired precision of table positioning.

### SUMMARY

An object of the present invention is to provide an indexing table provided with an activating mechanism allowing drawbacks of known solutions to be overcome, being simple to realize with low costs, reliable and accurate in positioning also with no electronic items for controlling the actuator.

Another object of the present invention is to provide an indexing table in which the number of indexes can be changed rather easily.

It is another object of the present invention to provide an indexing table providing higher torque while having the same size as known solutions.

Therefore, the present invention concerns an indexing table according to claim 1.

In particular, the present invention concerns an indexing rotary table comprising a body, a platform rotatable with respect to the body on a first axis Z, an actuator and an indexing mechanism arranged to rotationally activate the platform in response to the movement imparted by the actuator.

The activating mechanism in turn comprises a thrust plate coupled to the actuator and translatable in the body only in parallel with a second axis X orthogonal to the axis Z, alternately in the two ways. The thrust plate lies substantially on a plane orthogonal to the axis Z and is provided, on at least one face thereof, with guide grooves, or inner cams, transversal with respect to the axis X, and preferably directed at about 45° with respect to the latter.

The activating mechanism further comprises a double rack element provided with sliding blocks, or followers, each of which slidingly engages one of the guide grooves, or inner cams. The two racks are linear and directed in parallel to the axis X, being opposed and spaced with respect to the axis Z.

The activating mechanism further comprises a drive shaft, rotatably supported on the axis Z in an intermediate position between the two linear racks.

The drive shaft comprises a gear for the engagement with the two racks.

In a first arrangement, corresponding to an initial run of the thrust plate in one of the two directions, the double rack element is translatable in parallel with a third axis Y orthogonal to the axis X and the axis Z in order to move only one of the two racks into engagement with the gear of the drive shaft and to disengage the other rack, with no rotation transmitted to the drive shaft, and the sliding blocks slide in the corresponding guide grooves.

In a second arrangement, corresponding to the final run of the thrust plate in the same direction, the double rack element is translationally integral with the same thrust plate and drives into rotation the drive shaft; the sliding blocks are in the limit position in the respective guide grooves.

The reversal of the translation direction of the thrust plate corresponds to the reversal of the translation direction of the rack element in parallel with the axis Y, i.e. the rack engaged with the drive shaft is reversed and the operating cycle starts again.

The operation of the rotary table can be explained referring to the following sequential steps.

Step A)

The actuator is activated for translating the thrust plate in the table body in parallel with the axis X, for a first length of the respective run and in a first direction, so that to cause the sliding blocks of the double rack element to slide in respective guide grooves of the thrust plate. In this direction, the translation of the double rack element in parallel with the axis Y is obtained and, at the same time:

a rack of the drive shaft is disengaged and the other rack is moved into engagement with the same drive shaft without transmitting rotations to the latter, and

the sliding blocks of the double rack element are pushed to the limits of the respective guide grooves of the thrust plate.

Step B)

The actuator further translates the thrust plate in the table body in parallel to the axis X, for a second final length of the respective run and in the first direction, i.e. continuing the translation of step a). In this way, the translation of the double rack element integrally with the same thrust plate is caused and, at the same time:

the drive shaft is rotated on the axis Z of an angle proportional to the final length of the covered run, according to the gear ratio existing between the rack and the drive shaft engaged thereto. The thrust plate, at the limits, will stop.

Step C)

The actuator is activated to translate the thrust plate in the table body in parallel to the axis X, for a first length of the respective run and in the second direction opposite to the first way, i.e. in a way opposite with respect to steps a) and b). In this way, the sliding blocks of the double rack element slide in respective guide grooves of the thrust plate, in a way opposite with respect to step a), so as to cause the translation of the double rack element in parallel with the axis Y and, at the same time:

a rack of step b) is disengaged from the drive shaft and the other rack is moved into engagement with the same drive shaft without transmitting rotations to the latter, and

the sliding blocks of the double rack element are moved to the limits of the respective guide grooves of the thrust plate.

Step D)

The actuator further translates the thrust plate in the table body in parallel to the axis X, for a second final length of the respective run and in the second way, i.e. continuing the translation of step c). In this way, the translation of the double rack element integrally with the same thrust plate is caused and, at the same time:

the drive shaft is rotated on the axis Z of an angle proportional to the final length of the covered run, according to the gear ratio existing between the rack and the drive shaft engaged thereto.

The rotations of the drive shaft obtained in steps b) and d) are in the same way, clockwise or counter-clockwise.

A new step a) follows the step d) and the operation of the table starts again as described above.

In practice, the intermittent rotary motion is obtained by means of the described activating mechanism which provides that, during the transversal movement of the double rack element with respect to the thrust plate along the Y axis, no rotations are transmitted to the shaft, and during the integral movement of the double rack element with the thrust plate along the X axis, rotations proportional to the run of the rack engaged with the drive shaft are transmitted to the shaft itself.

The advantages offered by the indexing table according to the present invention are numerous.

Firstly, the table can be implemented with a pneumatic or electric actuator; the presence of electronic devices controlling the actuator is not necessary, whatever the actuator is, because the operation of the activating mechanism, described referring to steps a)-d), directly depends on its structure and not too much on the used actuator type.

The rack and pinion-type coupling obtained between the drive shaft and the double rack element ensures high precision and repeatability concerning the rotations imparted to the table, also in absence of electronic devices for controlling the actuator. For example, the described arrangement allows obtaining repeatability of angular positioning comprised in the range ±0.015° (sexagesimal degrees) and angular precision comprised in the range ±0.10°.

In addition, the operation of the activating mechanism produces little vibrations.

The structure of the indexing table, essentially mechanical, allows obtaining a high reliability and an extremely long lifetime. As a matter of fact, the components of the activating mechanism, although subjected to wear, withstand also a lot of working cycles before replacement becomes necessary.

On the other hand, the table according to the present invention is not as complex to assemble as compared with known solutions having planetary gears or expensive cams.

The absence of an electronic device for controlling the activating mechanism makes the table reliable also if it operates in environments having thermal variations, dirt, humidity, presence of aggressive substances, etc. For example, the table according to the present invention is able to operate correctly in a temperature range comprised between 5° C. and 60° C.

Preferably, the guide grooves are rectilinear and oriented at 45° with respect to both X and Y axes.

In the preferred embodiment, the thrust plate comprises a center through slot in which the drive shaft is inserted.

Preferably, the double rack element is arranged as a frame, with the two opposed and parallel racks extending parallel to the axis X, and being fixed one to the others at respective ends, from opposite sides with respect to the drive shaft, by crossbeams parallel to Y axis. In practice the drive shaft is between the two racks and between the two crossbeams.

Preferably, the table comprises at least one damping or breaking element interposed between the body and the thrust plate or else interposed between the body and the double rack element to damp the vibrations and slow down the run of the thrust plate at the respective limits, so as to slow down gradually and without shakes the table rotation until the complete stop.

In the preferred embodiment, the drive shaft comprises a lobate portion, or with a polygonal section. Such a portion is designed for moving into abutment against corresponding seats of the double rack element when the table is in the first above described arrangement. The lobate portion makes a shape coupling with the respective seats, preventing the drive shaft rotation but allowing the translation of the double rack element parallel to the axis Y. For example, the lobate portion can have a height-point star and the seats are hollows obtained in crossbeams of the double rack element in which one of the points inserts with play in a direction parallel to axis Y. The extent of this play defines the run of the rack element in the Y direction.

Preferably, the two crossbeams are fastenable to the racks in a plurality of discrete positions along the same racks. These positions determine as many centers-to-centers between the two crossbeams and correspond to the number of table indexes.

By modifying the run length of the thrust plate and the double rack element in steps b) and d) a corresponding change in the number of table indexes is possible. This can be obtained, for example, by increasing or decreasing the center-to-center between the two crossbeams of the double rack element.

In general, the actuator of the rotary table can be pneumatic or electric.

In the first case, the actuator comprises one or more pneumatic pistons, for example activated by compressed air, alternately movable in the table body and connected to the thrust plate.

In the second case, the actuator is an electric type and comprises an electric motor, one or more threaded screws rotated by the motor and, for each thrust screw, a translating assembly transmitting the motion to the thrust plate, all of which housed in the table body. In this circumstance, the translating assembly in its turn preferably comprises:

a tow slide meshing the respective thrust screw,

a cursor rotationally integral with the thrust plate and movable with respect to the tow slide in a direction parallel to the run of the same thrust plate, and

one or more balancing preloaded and elastic elements, interposed between the tow slide and the cursor.

### BRIEF DESCRIPTION OF THE DRAWINGS

Further characteristics and advantages of the present invention will be more evident from a review of the following specification of a preferred, but not exclusive, embodiment, shown for illustration purposes only and without limitation, with the aid of the attached drawings, in which:

FIG. 1 is a perspective view of an indexing table according to a first embodiment of the present invention;

FIG. 2 is an exploded perspective view of the indexing table shown in FIG. 1;

FIG. 3 is an exploded perspective view of some isolated components of the indexing table shown in FIG. 1;

FIG. 4 is a perspective, partially exploded, view of part of the indexing table shown in FIG. 1;

FIG. 5 is a perspective and sectional view of the indexing table shown in FIG. 1;

FIG. 6 is a top plan view of the indexing table shown in FIG. 1, partially disassembled, in a first arrangement;

FIG. 7 is a top plan view of the indexing table shown in FIG. 1, partially disassembled, in a second arrangement;

FIG. 8 is a top plan view of the indexing table shown in FIG. 1, partially disassembled, in a third arrangement;

FIG. 9 is a top plan view of the indexing table shown in FIG. 1, partially disassembled, in a fourth arrangement;

FIG. 10 is a perspective exploded view of a second embodiment of the indexing table according to the present invention;

FIG. 11 is a top plan view of the indexing table shown in FIG. 10, partially disassembled, in a first arrangement;

FIG. 12 is a vertical section view of the table shown in FIG. 10.

### DETAILED DESCRIPTION OF THE PREFERRED EMBODIMENTS

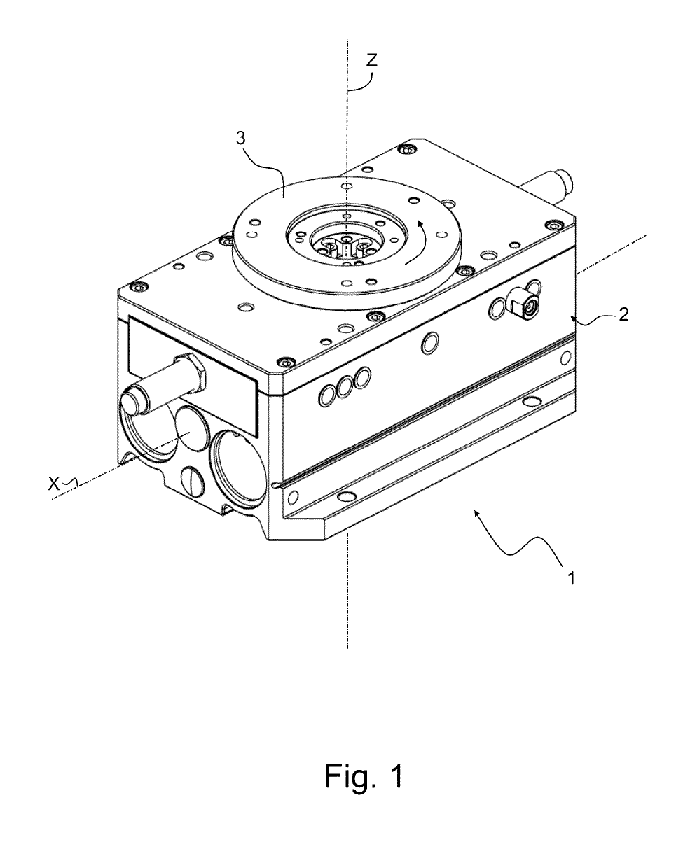

FIG. 1 is a perspective and overall view of an indexing table 1 according to a first embodiment of the present invention. With the numeral 2 the table body is indicated and with numeral 3 is indicated a platform rotating around a vertical axis Z, on which a table or platform is intended to be fixed for rotating with intermittent rotary motion among several stations.

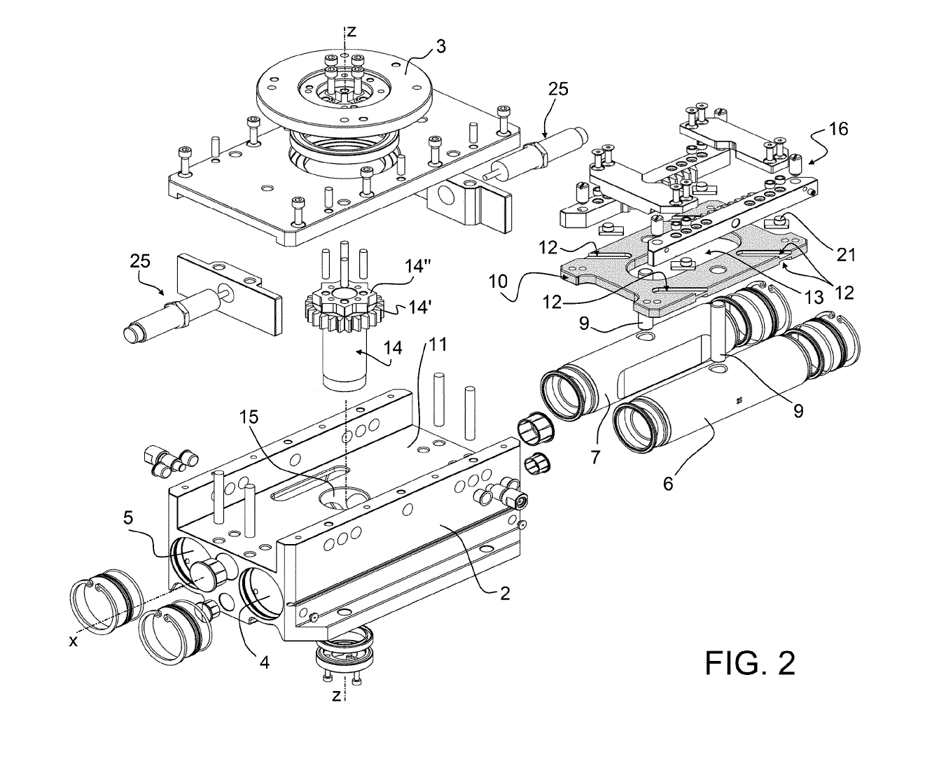

FIG. 2 is an exploded perspective view of the indexing table 1. Two cylinders 4 and 5, oriented in parallel to the longitudinal axis X and in which corresponding pistons 6 and 7 are housed and intended for moving with reciprocating translatory motion in the two ways, because of the inflow of compressed air, are obtained in the body 2.

Through the upper wall of the cylinders 4 and 5, two longitudinal and through slots 8 are obtained in which corresponding pins 9 are movable and constrain the pistons 6 and 7 to a thrust plate 10.

The thrust plate 10 is intended for being dragged on the surface 11 of the body 2, alternately in the two ways, by the pistons 6 and 7 to which they are coupled by means of the pins 9 translating inside the slots 8.

The thrust plate 10 is provided, at both its upper and lower faces, with four guide grooves 12, that is inner cams, extending in a direction substantially transversal to the axis X, for example they form an angle of 45° with such an axis. In particular, in all the grooves 12 are four on the upper face, two for each side of the plate 10, and they intercept the edge of the plate itself.

In the shown embodiment, the plate 10 is provided with grooves 12 on the lower face too, specular to the grooves 12 of the upper face. This allows mounting the plate in two positions according to the rotation direction of the table 1.

A through slot 13 extends centrally in the thrust plate 10. A drive shaft 14, constrained to the platform 3 and housed in a seat 15 of the body 2 by means of bearings, is fitted into the slot 13. The rotation axis of the shaft 14 is the axis Z.

The drive shaft 14 is rotatably supported in the body 2 by means of bearings (shown in FIG. 2 on bottom).

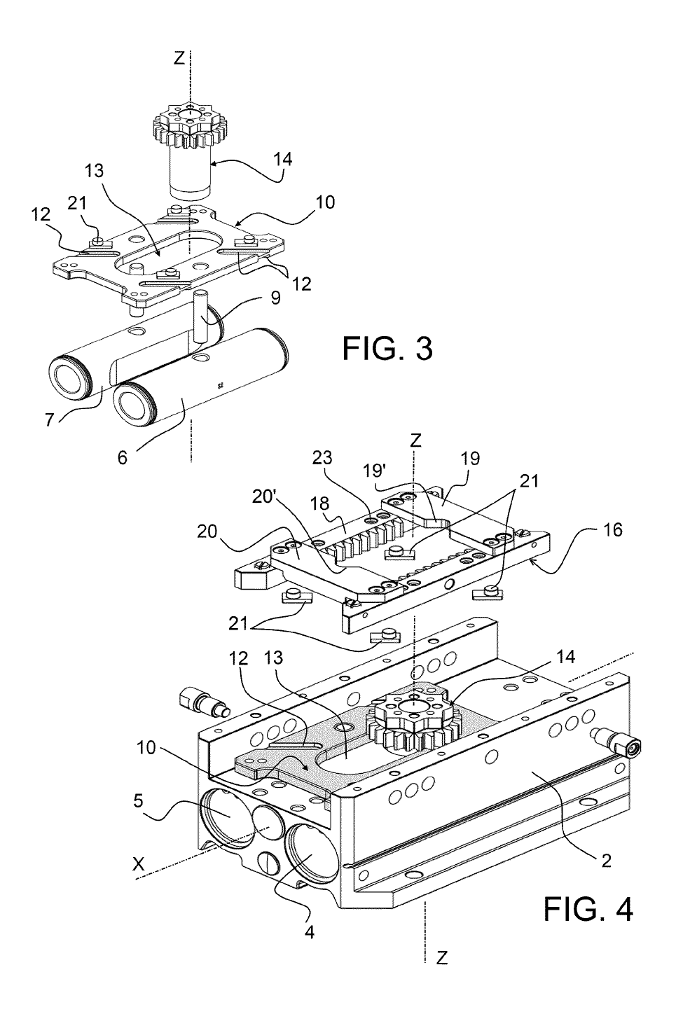

FIG. 3 shows in detail the pistons 6 and 7, the thrust plate 10 constrained to the pistons 6 and 7 by the pins 9 and the drive shaft 14 inserted in the slot 13 and longitudinally oriented with respect to the axis Z, all isolated from the other components of table 1.

FIG. 4 shown the table 1 as partially assembled, i.e. with some components omitted for clarity purposes. In particular, the thrust plate 10 is shown as housed in the body 2, slidable in both ways of a direction parallel to the axis X on the upper surface 2′ of the wall delimiting the cylinders 4 and 5 on top. As can be seen, the alternate translatory movement of the thrust plate 10 is caused by the pistons 6 and 7 and it is possible because the through slot 13 moves around the drive shaft 14, the latter being always aligned with the axis Y.

Over the thrust plate 10, but always housed inside the body 2 of the table 1, there is a double rack element 16. In the shown embodiment, such an element 16 comprises two linear racks 17 and 18, extending in parallel to the axis X, and two connecting crossbeams 19 and 20, extending in parallel to the axis Y orthogonal to the axis X.

The double rack element 16 is shaped as a framework or frame extending around the drive shaft 14 too, meaning that the crossbeams 19 and 20 constrain the racks 17 and 18 at the respective ends. The crossbeams 19 and 20 can be constrained to the racks 17 and 18 through the screws 22 meshing the holes 23 provided on the racks 17 and 18. On the racks 17 and 18 there are several holes 23 to allow the crossbeams 19 and 20 to be positioned according to a plurality of centers-to-centers that, as will be described below, correspond to the number of table indexes, i.e. the number of stations in which the stop of the platform 3 is provided. In practice, by increasing or decreasing the center-to-center of the crossbeams 19 and 20, the working run of the racks 17 and 18 is adjusted correspondingly. In other terms, the gap among the two racks 17 and 18 and the two crossbeams 19 and 20 can be varied in the X direction in order to vary the limits of the two racks 17 and 18.

The double rack element 16 is constrained to the thrust plate by the interposition of sliding blocks 21. Each sliding block 21 is intended for sliding in a corresponding guide groove 12 of the thrust plate 10 thereby creating a cam and follower type coupling. In the shown embodiment, in all the sliding blocks 21 are four and in practice the double rack element 16 rests on the thrust plate just by the sliding blocks 21.

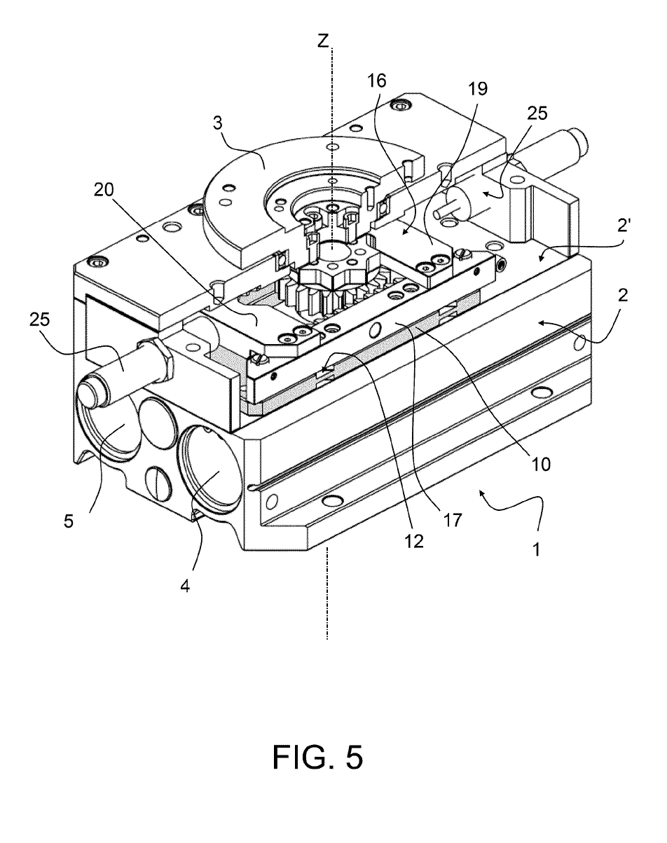

FIG. 5 is a perspective and partially sectional view of the indexing table 1 as assembled. For better clarity the right rack 17 has been omitted, so as to better show the relative position of the double rack element 16 with respect to the drive shaft 14. In this view, the double rack element 16 rests on the thrust plate 10 by the sliding blocks 21. Both elements 16 and 10 surround the drive shaft 14.

Two elastic elements 25, for example dampers, are interposed between the double rack element 16 and the body 2 of the table 1 and are aligned on the axis X, their function being to gradually slow down the run of the element 16 at the limits, i.e. at a stop station of the platform 3. In table 1 shown in figure, the elastic elements 25 are spring dampers.

As can be seen in FIGS. 2 and 5, the drive shaft 14 is directly screwed on the platform 3; therefore, rotations imparted by the shaft 14 on the axis Z are directly transmitted to the platform 3 with equal rotation speeds.

Coming back to FIG. 2, numeral 14′ indicates a toothed portion of the drive shaft 14, for example an item portion or a keyed gear, and with the numeral 14″ a lobate portion, or shaped with polygonal section, is indicated, specifically having a section in the shape of an eight-point star.

The toothed portion 14′ is intended for meshing the racks 17 and 18 of the element 16.

The lobate portion 14″ is intended for engaging alternately the corresponding seat 19′ and 20′ of the crossbeams 19 and 20 of the double rack element 16.

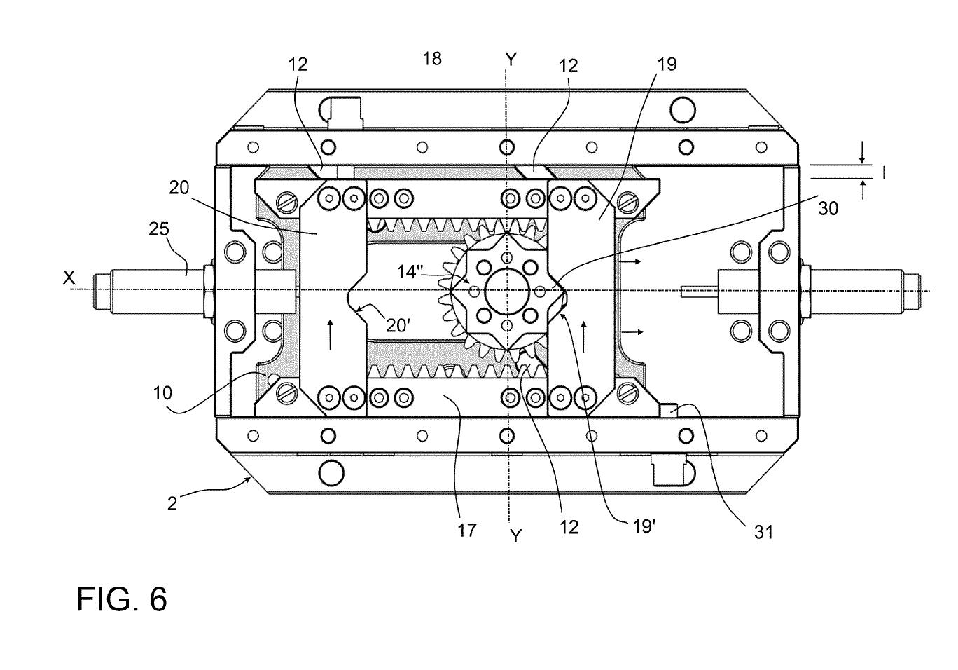

The operation of the table 1 will be now explained referring to FIGS. 6 to 8, which show the reciprocal position of some components of the table in four different steps.

FIG. 6 shows the table 1 in a first position in which the drive shaft 14 is stationary, i.e. it does not rotate on the axis Z. Therefore, the platform 3 is stationary too. The double rack element 16 is laterally in abutment (axis Y) with the rack 17 on the body 2, whereas between the rack 18 and the body 2 a gap I is defined. The rack 18 meshes the toothed portion 14′ of the drive shaft 14, whereas the rack 17 is separated from the same portion 14′ and does not engage it. A tip 30 of the lobate portion 14″ engages the seat 19′ obtained in the crossbeam 19; the coupling provides for some play in a direction parallel to the axis Y. The left damper 25 is compressed: the crossbeam 20 is in abutment against it because the element 16 is at the limit. A stop 31 prevents the displacement of the element 16 rightwards. The thrust plate 10 is on the left at the limit (initial position).

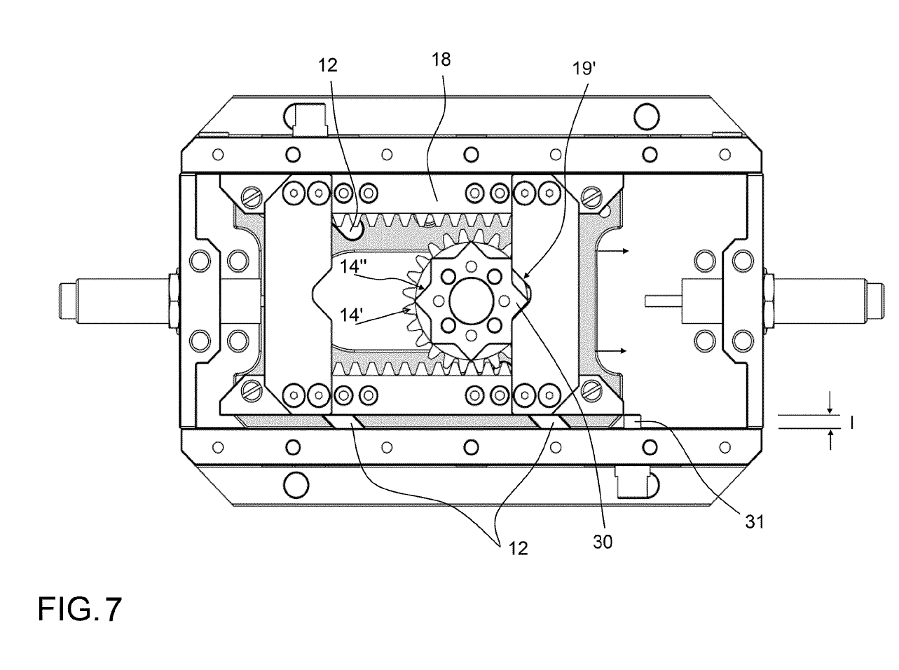

FIG. 7 shows the position the table 1 adopted subsequently. The thrust plate 10 has been translated rightwards due to the movement of pistons 6 and 7. Accordingly, the guide grooves 12 have pushed the respective sliding blocks 21 upwards; the whole element 16 has been subjected to a sidestep movement parallel to the axis Y thereby closing the gap I shown in FIG. 6, i.e. leading the crossbeam 18 in abutment against the body 2. The rack 18 has then been pushed to disengage from the toothed portion 14′ of the drive shaft and the crossbeam 17 has, on the contrary, meshed the shaft 14. The sidestep movement of the double rack element 16 is possible since the lobate portion 14″ is sliding in the seat 19′.

The comparison between FIGS. 6 and 7 shows as the double rack element 16 displaced in parallel with the axis T in response to the movement of the thrust plate 10 in parallel to the axis X. The arrows indicate the displacement direction. As afore explained, this is due to the fact that the guide grooves 12 are tilted at 45° with respect to both axes.

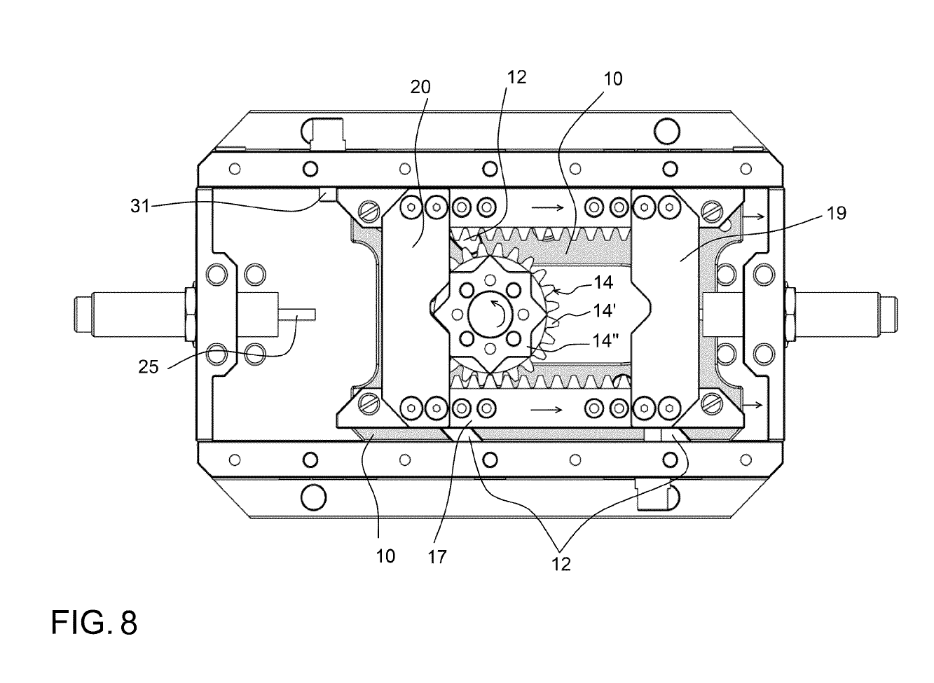

FIG. 8 shows the table 1 in a third position, subsequent to the second position during the table operation. The thrust plate 10 and the double rack element 16 are displaced rightwards, in the direction the arrows indicate. The sliding blocks 21 are at the limit in the respective guide groove 12, i.e. they are at the inner end of the respective guide; in this circumstance, the movement of the sliding blocks with respect to the guide grooves 12 is impeded and the sliding blocks are forced to move integrally with the same grooves 12 in parallel with the axis X. In other words, in this arrangement the thrust plate 10 drags the element 16 integrally towards the respective limit determined by the interaction between the lobate portion 14″ and the crossbeam 20. The translation rightwards of the double rack element 16 leads the rack 17 to drive the drive shaft 14 into an counter-clockwise rotation of an angle corresponding to the working run of the rack 17 itself.

One of ordinary skill in the art will understand that the run of the rack 17 depends also on the center-to-center existing between the crossbeams 19 and 20. By increasing this center-to-center, i.e. spacing out the two crossbeams 19 and 20 by fastening them to the respective racks 17 and 18 so that they are more distant one from another, the run of the racks is increased and, correspondingly, the number of table indexes is decreased, i.e. the angle of each rotation driven to the shaft 14 and the platform 3 is increased. Vice versa, by decreasing the center-to-center between the crossbeams 19 and 20, an increase of the number of table indexes is caused, i.e. the angle corresponding to each rotation driven to the platform 3 is correspondingly decreased.

The gear ratio between the toothed portion 14′ of the shaft 14 and the racks 17 and 18 determines the rotation speed of the platform 3.

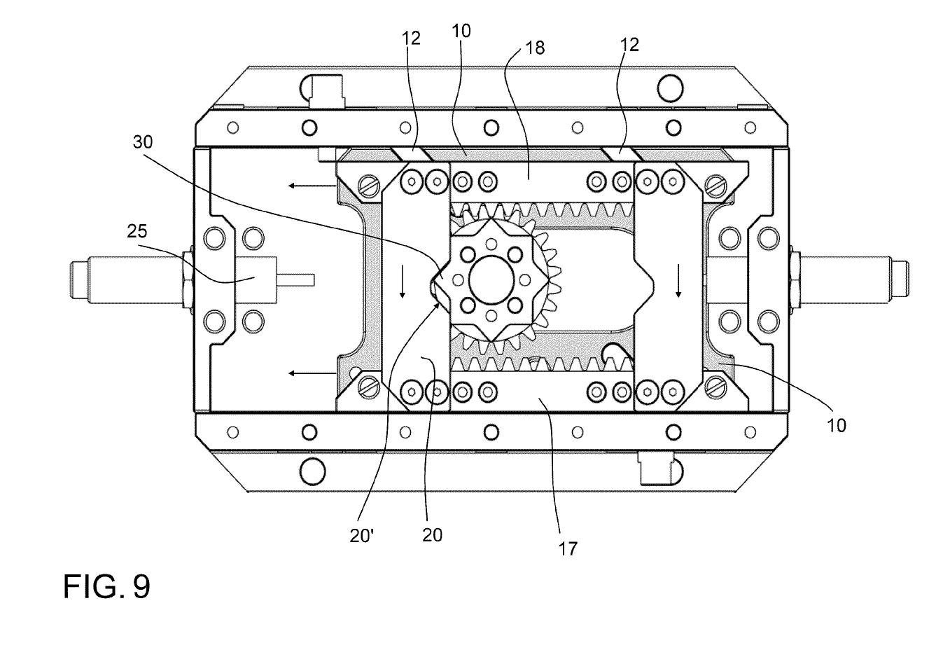

FIG. 9 shows a fourth position in which the thrust plate 10 starts the backward run, i.e. from the limit position reached on the right it moves towards the initial position shown in FIG. 6. The sliding blocks 21 are pushed in a direction contrary to the direction followed for arriving to the position shown in FIGS. 7 and 8. Correspondingly, the double rack element 16 does not move in parallel to the axis X but only in parallel to the axis Y. The platform 3 is then stationary. No rotation is transmitted to the shaft 14. The respective lobate portion 14″ slides on the crossbeam 20 for a length corresponding to the play that became clear between the tip 30 and the seat 20′. At the end of the translation of the thrust plate 10, the table comes back to the arrangement shown in FIG. 6.

The described positions are cyclically repeated to drive the rotations of the platform 3.

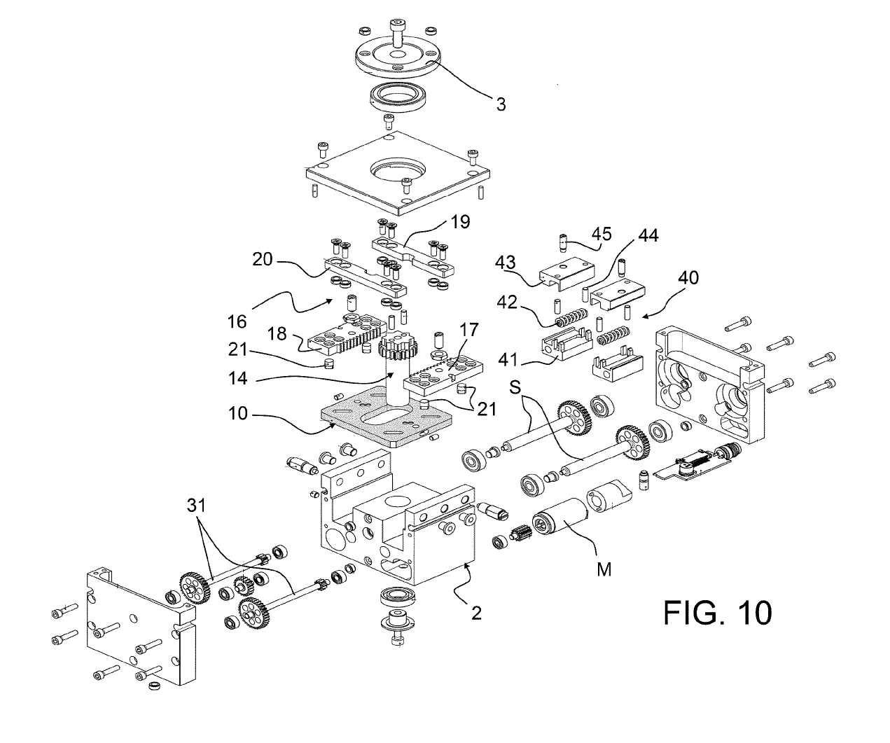

FIG. 10 is a perspective exploded view of a second embodiment of the indexing table 1′ according to the present invention, in which the actuator is not pneumatic, but rather electric. The rest of the table 1′ comprises substantially the same activating mechanism of the system shown in FIGS. 1 to 9: the body 2, the thrust plate 10 provided with groove 12 tilted at 45°, a double rack element formed by the racks 17 and 18 and the crossbeams 19 and 20, a drive shaft 14 fixed to the platform 3, etc. FIG. 12 shows this embodiment in a position equivalent to that shown in FIG. 6 for the first embodiment.

The actuator comprises an electric motor M housed in the body 2. The motor drives the translation of the translating assemblies 40 through the backward screws 31 and the thrust, or drive, screws, the assemblies meshing on the screwed portion of the screws S.

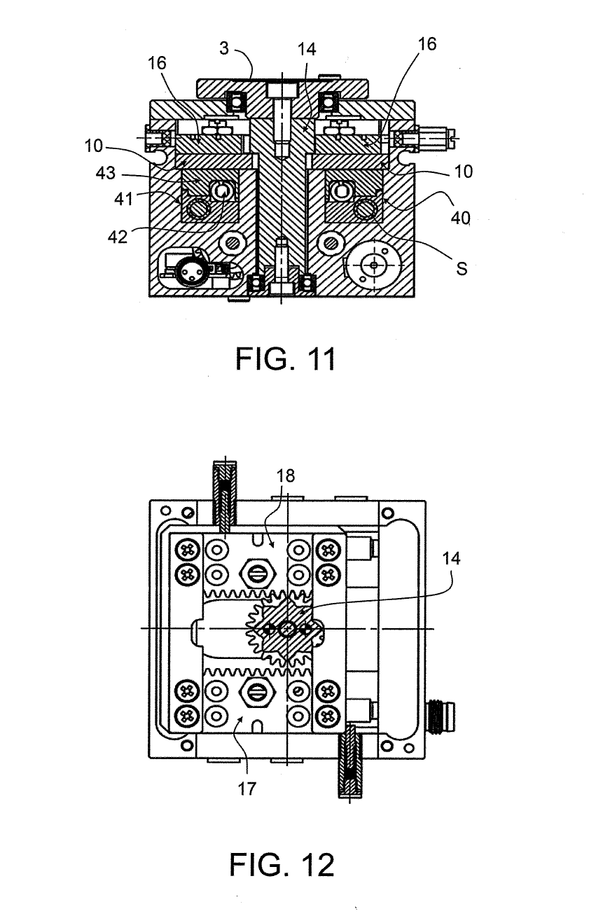

As shown in FIGS. 10 and 11, each translating assembly 40 comprises a tow slide 41 that is threaded at its underside or provided with a threaded hole, to engage the threaded shank of the respective thrust screw S. The tow slide 41 supports the cursor 43 mounted so as to slide with respect to the same tow slide 41. Between the slide 41 and the cursor 43 a coil spring 42 is interposed, not only in a material way, but above all in an operational way. The coil spring 42 is compressively pre-loaded during the assembling step, directly by the manufacturer. If needed, the springs 42 can be replaced by springs having a different preload.

The so-composed translating assembly 40 forms a device elastically compensating the runs of the thrust plate 10. Therefore, the translating assemblies 40 perform also the task of dampening, equivalent to what has been described referring to dampers 25.

The pins 44 are integral with the cursor 41 and jut towards the tow slide 43 such that they act as plungers of the springs 42 when the cursor 41 translates with respect to the tow slide 43. The pins 44 can be inserted between the shoulders of the slide 43 that define the seat of the spring 42. Substantially, the tow slide 41 translated by the screw S, always runs a fixed travel, whereas the cursor 43 can also translate with respect to the tow slide 41 and make runs variable within certain limits according to the resistance to movement the kinematic chain, composed of the platform 3, the shaft 14, the rack 17 or 18 and the thrust plate 10, meets in rotating the platform 3. The springs 42 are compressed for absorbing exceeding force that, otherwise, would be applied on the platform 3.

1. Indexing rotary table comprising a body, a platform rotatable with respect to the body on a first axis Z, an actuator and an indexer defining an activating mechanism arranged to rotationally activate the platform in response to the movement imparted by the actuator, wherein the activating mechanism comprises in its turn:
a thrust plate coupled to the actuator and translatable in the body only in parallel with a second axis X orthogonal to the axis Z, alternately in the two directions, wherein the thrust plate lies substantially on a plane orthogonal to the axis Z and is provided, on at least one face thereof, with guide grooves, or inner cams, directed at about 45° with respect to said axis X;
a double rack element provided with sliding blocks, or followers, each of which slidingly engages one of said guide grooves, or inner cams, and is provided with two linear racks directed in parallel to the axis X, which are opposed and spaced with respect to the axis Z;
a drive shaft, rotatably supported on the axis Z in an intermediate position between the linear racks, wherein the drive shaft comprises a toothed portion for the engagement with the two racks,
wherein in a first arrangement, corresponding to an initial run of the thrust plate in one of the two directions, the double rack element is translatable in parallel with a third axis Y orthogonal to the axis X and the axis Z in order to disengage a first of the two racks of the drive shaft and to move the second of the two racks into engagement with the toothed portion of the drive shaft, with no rotation transmitted to the drive shaft itself, and the sliding blocks slide in the corresponding guide grooves, and
wherein in a second arrangement, corresponding to the final run of the thrust plate in the same direction, the double rack element is translationally integral with the same thrust plate and drives into rotation the drive shaft, and the sliding blocks are in the limit position of the respective guide grooves, and wherein
the reversal of the translation direction of the thrust plate corresponds to the obtaining of the first and the second arrangement, sequentially, with the second rack engaging the shaft.

2. The indexing rotary table according to claim 1, wherein the guide grooves are rectilinear and oriented at 45° with respect to both X and Y axes.

3. The indexing rotary table according to claim 1 wherein the thrust plate comprises a central and through slot in which the drive shaft is inserted.

4. The indexing rotary table according to claim 1, wherein the double rack element is arranged as a frame, the two opposed racks being fixed one to the others at respective ends, from opposite sides with respect to the drive shaft, by crossbeams parallel to Y axis.

5. The indexing rotary table according to claim 1, further comprising, at each of the two stops of the thrust plate, at least one damping or breaking element interposed between the body and the thrust plate or else interposed between the body and the double rack element to slow down the rotation of the platform until a complete stop thereof.

6. The indexing rotary table according to claim 1, wherein the drive shaft comprises a lobate portion, or with polygonal section, which is intended to move into abutment against corresponding seats of the double rack element, in said first arrangement, to shape couple with the seats thereby preventing the rotation of the drive shaft but allowing the translation of the double rack element in parallel with the Y axis.

7. The indexing rotary table according to claim 6, wherein said seats are two, both defined in a corresponding crossbeam fixed to both racks, orthogonally with respect to the latter, in order to define a center-to-center between the two crossbeams in which the drive shaft is present, and wherein the two crossbeams are fastenable to the racks in a plurality of discrete positions along the racks themselves, which are corresponding to as many centers-to-centers between the two crossbeams and corresponding to the number of table indexes.

8. The indexing rotary table according to claim 1, wherein the thrust plate is provided with guide grooves at both of its faces, the guide grooves being specular between a face and the other, in order to combine a desired face to the double rack element during the assembling step, depending on whether the rotation of the table is clockwise or counter-clockwise.

9. The indexing rotary table according to claim 1, wherein on at least one of the two faces of the thrust plate there are four guide grooves, disposed in parallel couples so that each couple intercepts at 45° an edge of the thrust plate that is parallel to the X axis.

10. The indexing rotary table according to claim 1, wherein the actuator is a pneumatic type actuator and comprises at least one cylinder realized in the table body and fed with a pressurized fluid in which a piston moved by such a fluid is alternately translatable, and wherein the piston is constrained to the thrust plate to give the same alternate and continuous translation movements to the latter.

11. The indexing rotary table according to claim 1, wherein the actuator is an electric type actuator and comprises, all housed in the table body, an electric motor, at least one thrust screw rotated by the motor and, for each thrust screw, a translating assembly comprising, in its turn:
a tow slide meshing a respective thrust screw,
a cursor rotationally integral with the thrust plate and movable with respect to the tow slide in a direction parallel to the run of the same thrust plate, and
one or more balancing preloaded and elastic elements, interposed between the tow slide and the cursor.

12. Method for activating the indexing table according to claim 1, comprising the following consecutive steps:
a) activating the actuator to translate the thrust plate in the body of the table in parallel to axis X, for a first length of the respective run and in a first direction, causing the sliding blocks to slide in the respective guide grooves of the thrust plate and causing the double rack element to translate in parallel with the axis Y and at the same time:
disengaging a first rack of the drive shaft and moving the other rack into engagement with the same drive shaft without transmitting rotations to the latter, and
moving the sliding blocks to limits of the respective guide grooves of the thrust plate;
b) further translating the thrust plate in the body of the table in parallel with axis X, for a second final length of the respective run and in the first direction, causing the double rack element to integrally translate with the thrust plate itself and at the same time:
rotating the drive shaft on the axis Z of an angle proportional to the final length of the covered run, according to the gear ratio existing between the rack and the drive shaft engaged thereto;
c) activating the actuator to translate the thrust plate in the body of the table in parallel to axis X, for a first length of the respective run and in a second direction opposite to the first direction, causing the sliding blocks of the double rack element to slide in the respective guide grooves of the thrust plate, in the direction opposite with respect to step a), so that to cause the double rack element to translate in parallel with the axis Y and at the same time:
disengaging the second rack from the drive shaft and moving the first rack into engagement with the same drive shaft without transmitting rotations to the latter, and
moving the sliding blocks of the double rack element to limits of the respective guide grooves of the thrust plate;
d) further translating the thrust plate in the body of the table in parallel with the X axis, for a second final length of the respective run and in the second direction, causing the double rack element to integrally translate with the thrust plate itself and at the same time:
rotating the drive shaft on the Z axis of an angle proportional to the final length of the covered run, according to the gear ratio existing between the rack and the drive shaft engaged thereto;
wherein the rotations of the drive shaft obtained in steps b) and d) are in the same direction, clockwise or counter-clockwise.

13. The method according to the claim 12, further comprising:
e) modifying the run length of the thrust plate and the double rack element in steps b) and d) to correspondingly change the number of table indexes.
